(19) United States
(12) Patent Application Publication
(10) Pub. No.: US 2016/0159629 A1
(43) Pub. Date: Jun. 9, 2016

(54) MANUAL VEHICLE LIFT MECHANISM

(71) Applicant: BAC INDUSTRIES, INC., Miltona, MN (US)

(72) Inventors: Robert H. Lusty, Alexandria, MN (US); James D. Oberg, Eagle Bend, MN (US)

(21) Appl. No.: 14/561,253

(22) Filed: Dec. 5, 2014

(51) Int. Cl. B66F 7/06

(52) U.S. Cl. CPC B66F 7/0633

(57) ABSTRACT

A manually activated vehicle lift mechanism comprises a base and a vehicle support member with a generally two-piece, L-shaped, first-class lever pivotally connected to the base and forming the fulcrum point. The vehicle support member joins to an end of a shorter one of the legs of the L-shaped lever such that when its longer leg, i.e., its handle, is rotated in a first direction, the vehicle support is elevated. Rotation of the handle in an opposite direction again lowers the vehicle support.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

This invention relates generally to devices for elevating a vehicle from the ground and more particularly to a manual, lever-operated, lift mechanism for vehicles, such as lawn tractors, riding lawnmowers, golf carts, ATVs and the like, to allow ease of maintenance and servicing thereof.

2. Discussion of the Prior Art

There are disclosed in the prior art many devices that can be used for jacking up or elevating small vehicles, like motorcycles, lawnmowers, lawn and garden tractors, golf carts and the like, to facilitate maintenance and repair of the vehicles. They typically incorporate a base, a vehicle wheel support structure and a mechanism for elevating the wheel support structure from ground level to a predetermined height off of the ground.

For example, the Drake U.S. Pat. No. 8,141,850 utilizes a relatively expensive tooth and ratchet mechanism along with a winch for raising a wheel support from the ground.

The Bettencourt U.S. Pat. No. 6,966,542 utilizes a hydraulic jack to raise a four bar linkage that is coupled to a vehicle lift. The inclusion of the hydraulic jack necessarily increases the cost of manufacture of the overall lift device. Still other patents disclose electric motor-driven screws as a mechanism for raising wheel supports from a base. This, too, is a relatively costly approach.

Additional examples of prior art include U.S. Pat. Nos. 7,823,861; 8,251,349; 8,540,214; 6,345,807; 6,338,470; 5,716,061; and 5,358,217. These prior art arrangements all have one thing in common. They are all relatively costly to produce when compared to the device described herein.

It is accordingly an object of the present invention to provide a low cost, easy to operate vehicle lift mechanism utilizing a manually actuated lever to raise a vehicle wheel support mechanism from ground level to a height where servicing of the undercarriage of the vehicle can be carried out.

### SUMMARY OF THE INVENTION

In accordance with the present invention, a lift device for lawn care vehicles comprises a base having a pair of elongated bars connected in parallel spaced relation by a transversely extending bar member such that the base is arranged to sit on a ground surface. First and second elongated support arms are pivotally joined at a first end thereof to the base at a point adjacent the pair of elongated bars of the base. The arms are maintained parallel to one another by a tubular cross member pivotally coupled to the second ends of the first and second support arms.

Projecting out from opposed ends of the tubular cross member are vehicle wheel supports. Completing the lift device is a lever mechanism for raising and lowering the vehicle wheel supports relative to a floor surface. The lever mechanism comprises an elongated handle member rigidly affixed at a predetermined angle to a lift bar. The handle member with the attached lift bar is pivotally attached to the transversely extending bar that is part of the base proximate its midpoint. The second end of the lift bar pivotally connects to the tubular cross member affixed to the outer ends of the first and second support arms. This somewhat L-shaped lever is designed such that as the handle member is manually moved by an operator toward the ground, the wheel supports reach an over-center position wherein the weight of the vehicle urges the handle more firmly against the ground, creating a stable condition of the lift where the vehicle wheel supports are in their elevated state. A pair of air springs is pivotally joined at one end to the pair of elongated bars of the base at points offset from the pivotal attachment of the arms to the base and at the other end to the arms.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which:

FIG. 1 is a perspective frontal view of the lift apparatus when in its lowered disposition;

FIG. 2 is a frontal perspective view with the lift in its elevated disposition; and

FIG. 3 is a view of the lift device when elevating a riding lawnmower.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion, These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise, Also, as used herein, “small vehicle” is meant to include riding lawn mowers, garden tractors, golf carts and ATVs.

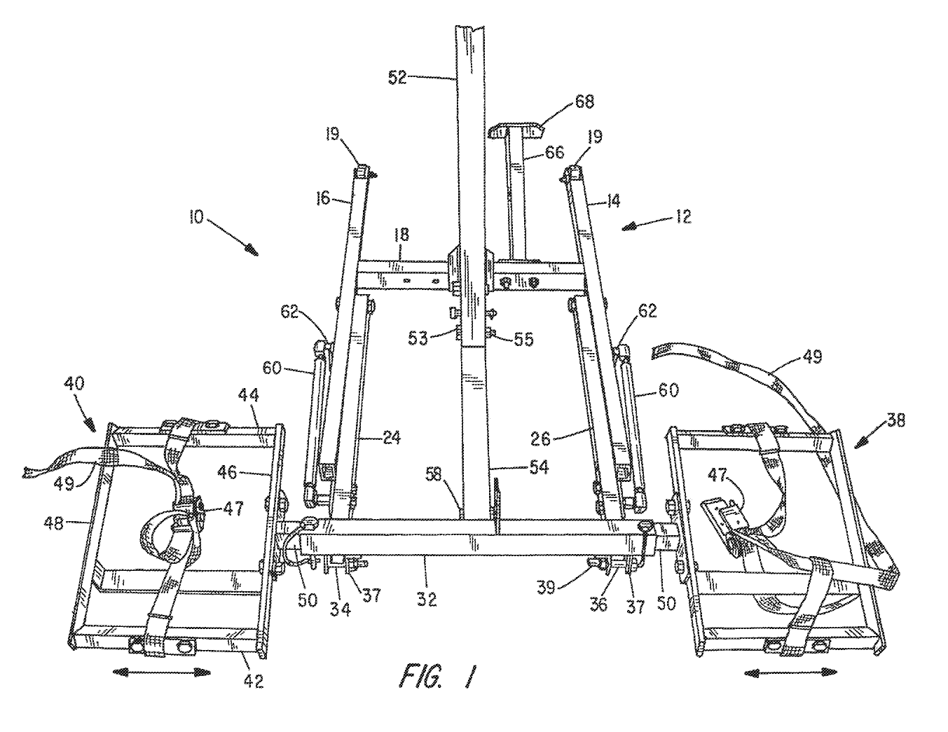

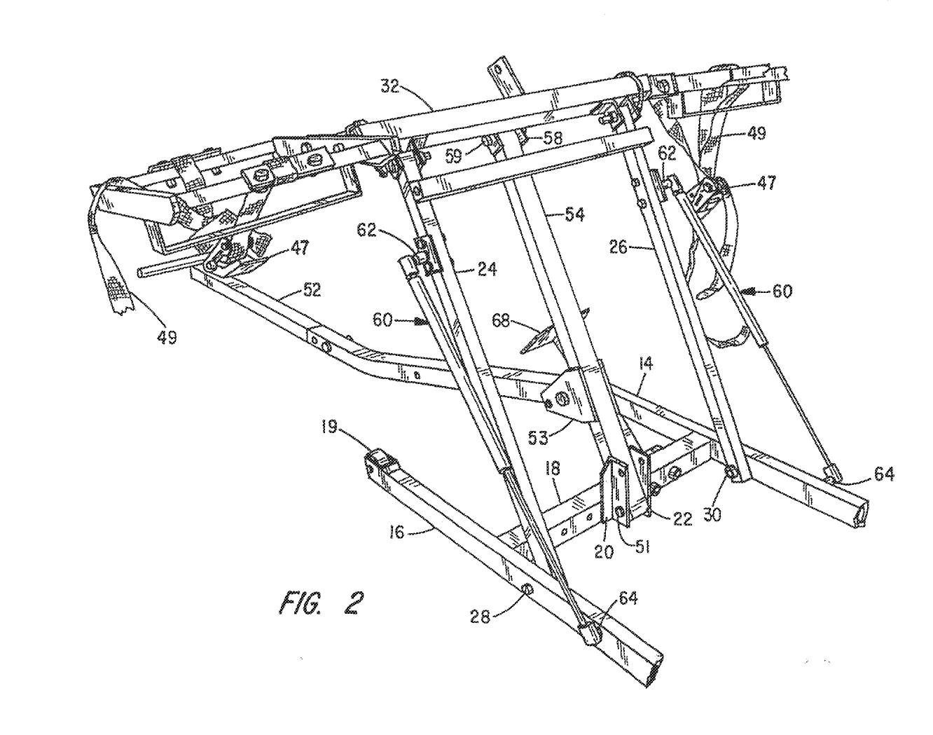

Referring to FIGS. 1 and 2, there is shown a view from the front of the manually operated small vehicle lift mechanism of the present invention. It is indicated generally by numeral 10 and in FIG. 1 is seen to include a base 12 comprising a pair of elongated tubular bars 14, 16 of rectangular cross-section that are connected in parallel, spaced-apart relation by a transversely extending bar 18. The base is designed to rest on a flat surface, such as on the around or on the floor of a garage or other workplace. Wheels, as at 19, are appropriately journaled on the rear ends of the tubular bars 14, 16 to facilitate initial placement of the lift assembly,

Welded to the bar 18 are angle bars 20 and 22 (FIG. 2) that are spaced from one another. First and second elongated support arms 24, 26 are pivotally attached by hinge pins or bolts 28, 30 that pass through aligned holes in the elongated tubular bars 14, 16 and in a rear end portion of the elongated support arms 24, 26.

A tubular cross member 32 is pivotally connected to the forward ends 34, 36 of the support arms 24, 26, using clevis brackets 37 and hinge pins or bolts 39.

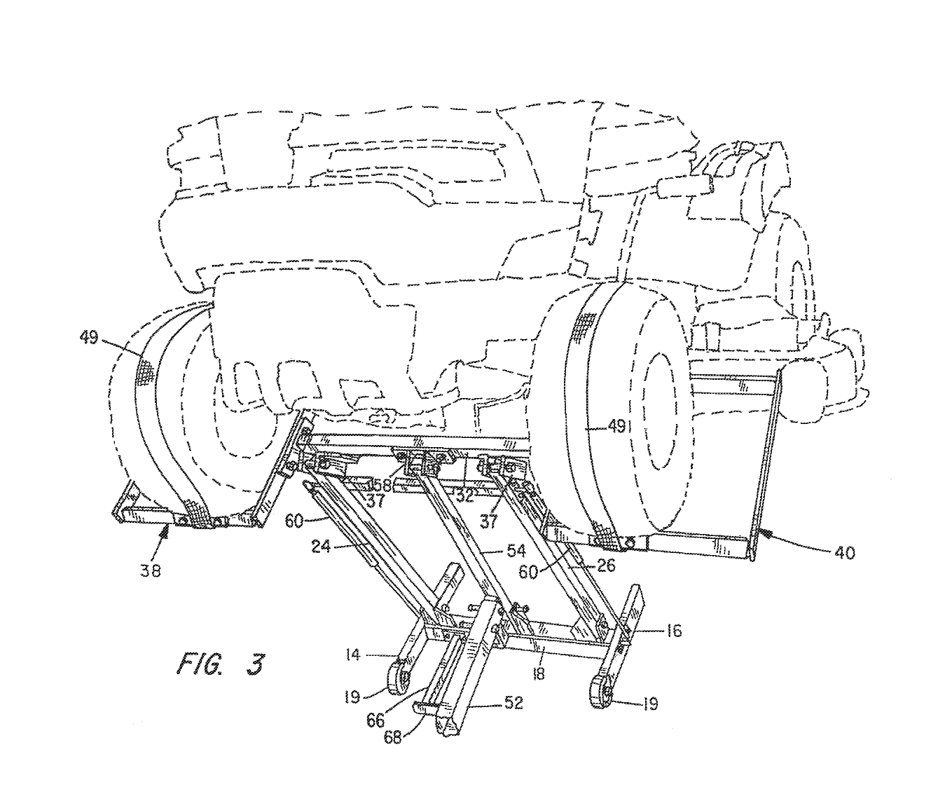

Also seen in FIGS. 1 and 2 is a pair of small vehicle wheel supports, indicated generally by numerals 38 and 40, that are telescopingly fitted into the opposed ends of the tubular cross member 32. The vehicle wheel supports may comprise an open, rectangular frame made up of front and rear, inner and outer bars 42, 44, 46, 48, respectively. The length of these bars is set so that a predetermined arc of a small vehicle's tires will fit within the frames comprising the wheel supports 38, 40 as best seen in FIG. 3. Straps, as at 49, join to the front and rear bars 42, 44 and are designed to wrap about the tires of a small vehicle. A suitable buckle 47 allows for tensioning of the strap on the tires.

The wheel supports 38 and 40 further include a stub axle member 50 that is bolted or otherwise affixed to the inner frame bars 46, The stub axle members 50 telescopingly fit within the lumen of the tubular cross member 32. The stub axle members 50 are sized to permit limited rotation of the wheel supports 38, 40 about an axis extending through the length dimension of the cross member 32.

To raise and lower the wheel supports 38, 40 relative to the base 12, a lever of the first class is operatively coupled between the spaced-apart angle bars 20 and 22 by a pivot pin or bolt 51 (FIG. 2). More particularly, an elongated handle 52 has a lift bar 54 rigidly joined between bracket plates 53, 55 at one end thereof at a predetermined angle to a lower end portion of the handle 52. The handle 52 with the lift bar 54 is pivotally coupled to the cross-bar 18 by which the bolt 51 serves as the lever's fulcrum.

The free end of the lift bar 54 is pivotally joined to the tubular crossbar 32 proximate the midpoint by a clevis bracket 58 that is welded to the tubular crossbar 32 proximate its midpoint. A bolt or pin 59 is made to pass through aligned holes in the clevis bracket 58 and a front end portion of the lift bar 54.

As seen in FIG. 2, the handle 52 is bent at an obtuse angle at a location along its length, allowing a proximal portion thereof to lay flat on a floor while its distal portion slopes upward to the point at bracket 53 where the handle 52 joins to the lift bar 54.

It has also proved expedient to connect a pair of gas springs, as at 60, between the base and the support arms 24 and 26. In this regard, the free ends of the gas springs' cylinders couple at a swivel 62 to the support arms 24 and 26 and the free ends of the gas springs' pistons couple at swivels 64 to the elongated bars 14 and 16.

As an ergonomic aid, also attached to the transversely extending bar 18 of the base is a foot rest comprising a post 66 extending upward at an inclined angle to the base 12 terminating in a foot pad 68.

In operation, the lift mechanism 10 is tilted back on its wheels 19 by manually urging the handle 52 downward and then the assembly 10 is pushed so as to be positioned closely adjacent the front or rear wheels of the small vehicle to be elevated. The vehicle is then either manually pushed or driven so that its front or rear wheels fall within the frames comprising the wheel supports 38 and 40, as best seen in FIG. 3. The operator next tightly wraps the straps 49 about the vehicle's wheels as a safety measure and applies a pushing force to an upper end of the handle 52, thereby rotating it about the clevis bolt or pin 51 and ultimately bringing the proximal portion of the handle 52 to rest on the ground. As the handle is so rotated, the lift bar 54 rigidly affixed to the handle will rise from its lowered disposition shown in FIG. 1 carrying the support arms 14, 16 and the tubular crossbar 32 with the wheel supports 38, 40 with it, thus raising one end of the vehicle from the ground as seen in FIG. 3. The gas springs 60 function to provide a lifting force as well, thus less exertion by the user is required. Repairs can now be more readily carried out on the vehicle's undercarriage.

Because of the angle at which the lift bar is affixed to the handle, as the handle 52 is being lowered to the ground, the weight of the vehicle being elevated passes through an over-center point such that the proximal portion of the handle 52 is forced against the ground by the weight of the load being elevated. This prevents instability. To again lower the vehicle to ground, a predetermined lifting force must be applied to the handle to bring the handle back off the ground and past the over-center point where now the operator must exert a pulling force on the handle as the vehicle is being lowered to the ground. The gas springs 60 aid in assuring that the vehicle is lowered slowly rather than abruptly.

A user may also wish to utilize the foot rest 66, 68 during lifting and lowering operation as a place to apply leg force as he or she manipulates the lever.

Because the wheel supports are free to rotate with respect to the crossbar 32, they can tip so that the front bars 42 abut the floor when the vehicle is driven onto the wheel supports, but then shift to a more horizontal disposition as the vehicle is being elevated.

It has been found that with a lift bar 54 inches in length and the handle being ______ inches, an adult can readily elevate a load of ______ pounds using the above-described lift mechanism.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A lift device for small vehicles comprising:
(a) a base having a pair of elongated bars connected in parallel, spaced-apart relation by a transversely extending bar member;
(b) first and second elongated support arms pivotally joined at first ends to the base adjacent the pair of elongated bars;
(c) a tubular cross member pivotally coupled to second ends of the first and second support arms, the tubular cross member maintaining the first and second support arms in parallel, spaced-apart relation;
(d) vehicle wheel supports projecting out from opposed ends of the tubular cross member; and
(e) a lever mechanism for raising and lowering the vehicle wheel supports relative to a floor surface, where the lever mechanism comprises an elongated handle member having first and second segments integrally joined at a predetermined angle to one another, the second segment being affixed to a lift bar, the lift bar being pivotally attached to the transversely extending bar proximate a midpoint thereof and a second end of the lift bar pivotally connected to the tubular cross member.

2. The lift device of claim 1 wherein the vehicle wheel supports each comprise front, rear, inner and outer bars forming a rectangular frame, the inner bars being affixed to stub shafts insertable into the opposed ends of the tubular cross member.

3. The lift device of claim 2 wherein the rectangular frame is sized to receive a predetermined arc of a small vehicle's tire therein.

4. The lift device of claim 1 wherein the predetermined angle is such that rotation of the handle member such that said first segment of the handle member is against a floor surface, the tubular cross member is placed over center with respect to the pivotal attachment of the lift bar to the transversely extending bar member such that a weight of the vehicle when being lifted forces the first segment of the handle member against the floor surface.

5. The lift device of claim 2 wherein a length dimension of the stub shafts permits lateral adjustment of the degree of separation of the rectangular frames with respect to one another.

6. The lift device of claim 1 and further including first and second gas spring members operatively coupled between the pair of elongated bars comprising the base and the first and second elongated support arms.

7. The lift device of claim 1 and further including a foot rest member affixed to the transversely extending bar member.
